(19) United States
(12) Patent Application Publication
(10) Pub. No.: US 2005/0046246 A1
(43) Pub. Date: Mar. 3, 2005

(54) Bicycle seat assembly

(76) Inventor: Daniel Shiau, Tainan City (TW)

Correspondence Address: HARNESS, DICKEY & PIERCE, P.L.C., P.O. BOX 8910, RESTON, VA, 20195, US

(21) Appl. No.: 10/649,937

(22) Filed: Aug. 28, 2003

(51) Int. Cl. B62J 1/00

(52) U.S. Cl. 297/215.11

(57) ABSTRACT

A bicycle seat assembly includes a seat frame, a back cushion and a seat member. The back cushion is mounted on an upwardly inclining section of the seat frame, and forms an obtuse angle with a horizontal plane. The seat member is mounted on a horizontally extending section of the seat frame, and has a top seating surface formed with a buttocks-receiving recess.

### BACKGROUND OF THE INVENTION

1. Field of the Invention

The present invention relates to a bicycle seat assembly, more particularly to a bicycle seat assembly that can support the back of the user.

2. Description of the Related Art

A conventional bicycle is usually provided with a seat saddle that is only capable of supporting the user's buttocks during riding. As such, the heavy load borne by the seat saddle can result in user discomfort during long-distance riding. Moreover, since the back of the user is typically arched during riding, the tip of the user's foot will contact the ground first when the bicycle is parked, which can cause the user to lose his balance.

A bicycle seat assembly that includes a seat frame, a back cushion mounted on an upper portion of the seat frame, and a seat member mounted on a lower portion of the seat frame, has been proposed heretofore. The back cushion serves to support the user's back so as to reduce the load borne by the seat member. However, in the aforesaid bicycle seat assembly, a seating surface of the seat member is disposed parallel to a horizontal plane, while a back supporting surface of the back cushion is disposed parallel to a vertical plane. Accordingly, since the back of the user is still arched during riding, the back cushion barely contacts the user's back. As a result, the reduction in the heavy load borne by the seat member is minimal.

### SUMMARY OF THE INVENTION

Therefore, the object of the present invention is to provide a bicycle seat assembly that can overcome the aforesaid drawbacks associated with the prior art.

According to the present invention, a bicycle seat assembly comprises a seat frame, a back cushion, and a seat member.

The seat frame includes a horizontally extending section with front and rear mounting parts, and an upwardly inclining section that inclines upwardly and rearwardly from the rear mounting part of the horizontally extending section.

The back cushion has a rear frame mounting side mounted on the upwardly inclining section of the seat frame, and a front back supporting side opposite to the frame mounting side and forming an obtuse angle with a horizontal plane.

The seat member is mounted on the front mounting part of the horizontally extending section of the seat frame, and has a narrower front edge, a wider rear edge opposite to the front edge in a first direction, and a pair of lateral edges opposite to each other in a second direction transverse to the first direction and interconnecting the front and rear edges. The seat member defines a longitudinal axis that extends in the first direction and that is disposed between the lateral edges.

The seat member has a top seating surface formed with a buttocks-receiving recess. The recess has a width measured in the second direction that is gradually reduced along the longitudinal axis from the rear edge to the front edge of the seat member. The recess further has a depth that is gradually increased from each of the lateral edges toward the longitudinal axis.

The recess further has a lowermost point on the longitudinal axis, and a cross-section along the longitudinal axis that includes a downwardly and forwardly curving portion extending from the rear edge of the seat member to the lowermost point, and an upwardly and forwardly inclining portion extending from the lowermost point to the front edge of the seat member. The upwardly and forwardly inclining portion forms an acute angle with the horizontal plane, and is generally perpendicular to the back supporting side of the back cushion.

Due to the arrangement and configuration of the back cushion and the seat member, the posture of the user can be corrected so as to ensure comfort during use.

### BRIEF DESCRIPTION OF THE DRAWINGS

Other features and advantages of the present invention will become apparent in the following detailed description of the preferred embodiment with reference to the accompanying drawings, of which:

FIG. 1 is a side view of a bicycle that incorporates the preferred embodiment of a bicycle seat assembly according to the present invention;

FIG. 2 is a side view of the preferred embodiment to illustrate angular relationships of a seat frame, a back cushion and a seat member;

FIG. 3 is a longitudinal cross-sectional view of the seat member; and

FIG. 4 is another cross-sectional view of the seat member, taken along lines IV-IV of FIG. 3.

### DETAILED DESCRIPTION OF THE PREFERRED EMBODIMENT

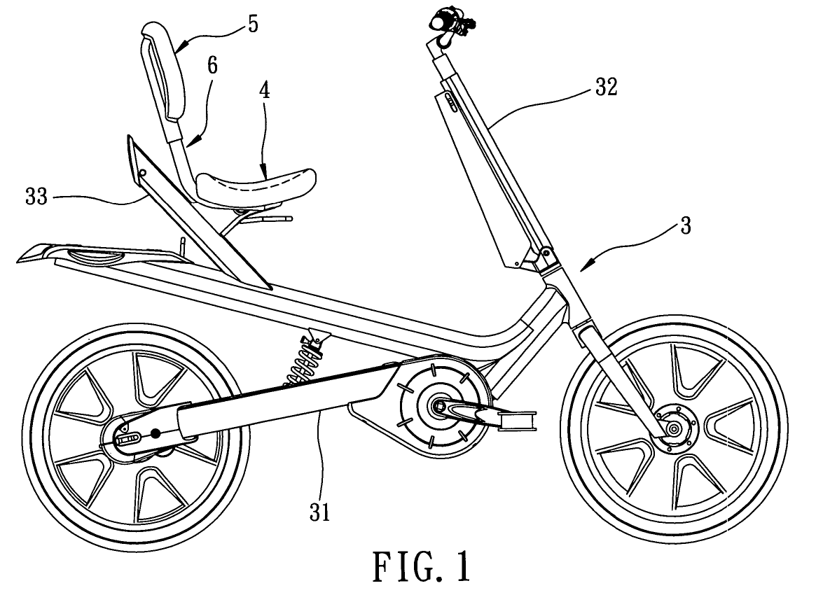

Referring to FIG. 1, the preferred embodiment of a bicycle seat assembly according to the present invention is shown to be mounted on a bicycle 3, which includes a bicycle frame 31, a handlebar unit 32 on a front end of the bicycle frame 31, and a seat post 33 on a rear end of.the bicycle frame 31. The bicycle seat assembly includes a seat frame 6, a back cushion 5 and a seat member 4.

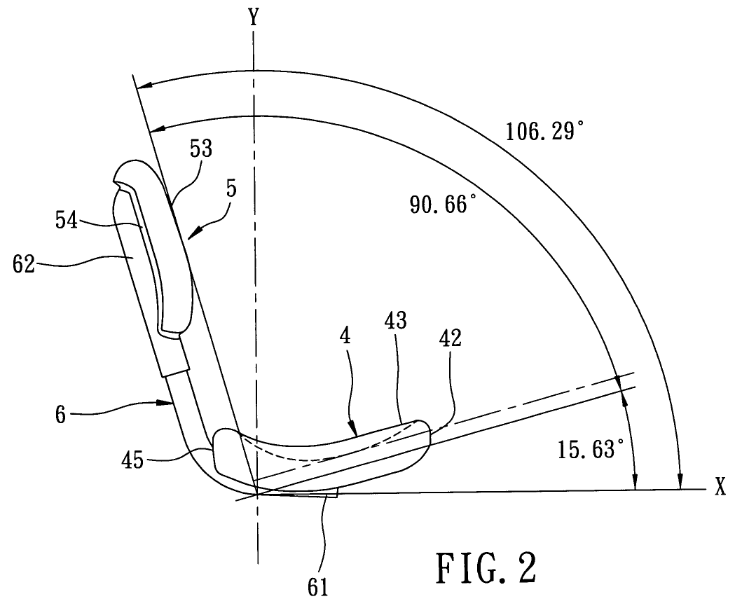

As shown in FIG. 2, the seat frame 6 includes a horizontally extending section 61 with front and rear mounting parts, and an upwardly inclining section 62 that inclines upwardly and rearwardly from the rear mounting part of the horizontally extending section 61. The horizontally extending section 61 is mounted on the seat post 33 (see FIG. 1).

The back cushion 5 has a rear frame mounting side 54 mounted on the upwardly inclining section 62 of the seat frame 6, and a front back supporting side 53 opposite to the frame mounting side 52 and forming an obtuse angle that ranges from 102 to 108 degrees (106.29 degrees in this embodiment) with a horizontal plane (X). The back supporting side 53 thus inclines rearwardly relative to a vertical plane (Y).

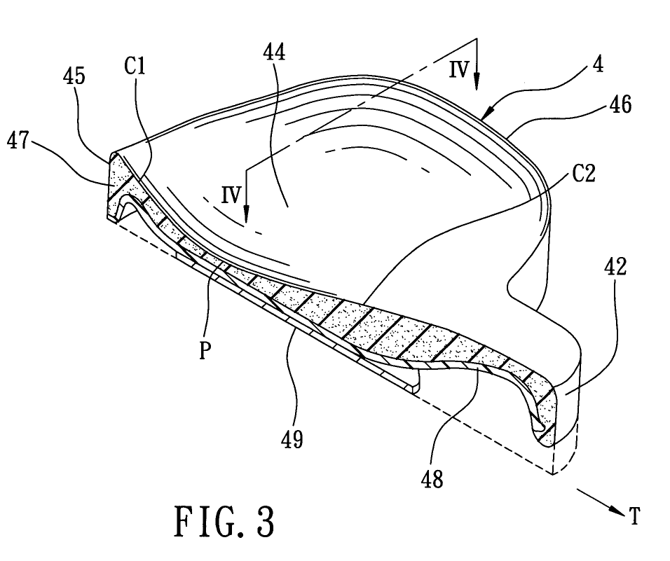

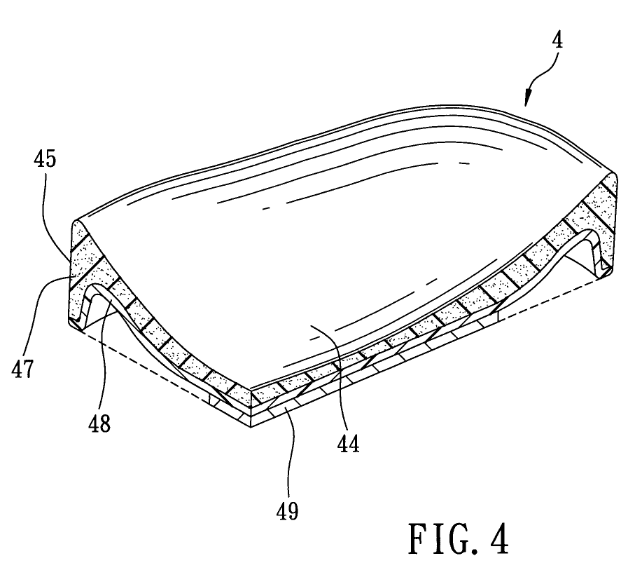

Referring further to FIG. 3 and 4, the seat member 4 is mounted on the front mounting part of the horizontally extending section 61 of the seat frame 6, and has a narrower front edge 42, a wider rear edge 45 opposite to the front edge 42 in a first direction, and a pair of lateral edges 46 (only one is shown in FIG. 3) opposite to each other in a second direction transverse to the first direction and interconnecting the front and rear edges 42, 45. The seat member 4 defines a longitudinal axis (T) that extends in the first direction and that is disposed between the lateral edges 46.

The seat member 4 has a top seating surface 43 formed with a buttocks-receiving recess 44, the shape of which conforms to that of the buttocks of the user. The recess 44 has a width measured in the second direction that is gradually reduced along the longitudinal axis (T) from the rear edge 45 to the front edge 42 of the seat member 4. The recess 44 further has a depth that is gradually increased from each of the lateral edges 46 toward the longitudinal axis (T), as best shown in FIG. 4.

The recess 44 further has a lowermost point (P) on the longitudinal axis (T), and a cross-section along the longitudinal axis (T) that includes a downwardly and forwardly curving portion (Cl) extending from the rear edge 45 of the seat member 4 to the lowermost point (P), and an upwardly and forwardly inclining portion (C2) extending from the lowermost point (P) to the front edge 42 of the seat member 4. The upwardly and forwardly inclining portion (C2) forms an acute angle ranging from 12 to 18 degrees (15.63 degrees in this embodiment) with the horizontal plane (X), and is generally perpendicular to the back supporting side 53 of the back cushion 5 (in this embodiment, an angle of 90.66 degrees is formed between the portion (C2) and the back supporting side 53). Structurally, the seat member 4 includes a seat cushion layer 47 made of foam, a backing layer 48 made of plastic, and a mounting plate 49 made of metal. The seat cushion layer 47 has a top side formed with the buttocks-receiving recess 44, and a bottom side. The backing layer 48 is mounted on the bottom side of the seat cushion layer 47 to help retain the shape of the seat cushion layer 47. The mounting plate 49 serves to mount the backing layer 48 on the horizontally extending section 61 of the seat frame 6.

In use, since the shape of the recess 44 conforms to that of the user's buttocks, pressure applied by the user's buttocks can be homogeneously distributed throughout the seat member 4. Moreover, in view of the inclined cross-section of the recess 44, the body of the user will be guided to recline toward the back supporting side 53 of the back cushion 5. As a result, arching of the user's back can be avoided such that the back cushion 5 and the seat member 4 share the load of the user. Furthermore, since the posture of the user is corrected, the foot of the user can rest flat on the ground when parking the bicycle so that the user can maintain his balance.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A bicycle seat assembly comprising:
a seat frame including a horizontally extending section with front and rear mounting parts, and an upwardly inclining section that inclines upwardly and rearwardly from said rear mounting part of said horizontally extending section;
a back cushion having a rear frame mounting side mounted on said upwardly inclining section of said seat frame, and a front back supporting side opposite to said frame mounting side and forming an obtuse angle with a horizontal plane; and
a seat member mounted on said front mounting part of said horizontally extending section of said seat frame, said seat member having a narrower front edge, a wider rear edge opposite to said front edge in a first direction, and a pair of lateral edges opposite to each other in a second direction transverse to the first direction and interconnecting said front and rear edges, said seat member defining a longitudinal axis that extends in the first direction and that is disposedbetween said lateral edges,
said seat member having a top seating surface formed with a buttocks-receiving recess, said recess having a width measured in the second direction that is gradually reduced along the longitudinal axis from said rear edge to said front edge of said seat member, said recess further having a depth that is gradually increased from each of said lateral edges toward the longitudinal axis,
said recess further having a lowermost point on the longitudinal axis, and a cross-section along the longitudinal axis that includes a downwardly and forwardly curving portion extending from said rear edge of said seat member to said lowermost point, and an upwardly and forwardly inclining portion extending from said lowermost point to said front edge of said seat member, said upwardly and forwardly inclining portion forming an acute angle with the horizontal plane and being generally perpendicular to said back supporting side of said back cushion.

2. The bicycle seat assembly as claimed in claim 1, wherein the acute angle ranges from 12 to 18 degrees.

3. The bicycle seat assembly as claimed in claim 1, wherein the obtuse angle ranges from 102 to 108 degrees.

4. The bicycle seat assembly as claimed in claim 1, wherein said seat member includes:
a seat cushion layer having a top side formed with said buttocks-receiving recess, and a bottom side;
a backing layer mounted on said bottom side of said seat cushion layer to help retain shape of said seat cushion layer; and
a mounting plate for mounting said backing layer on said horizontally extending section of said seat frame.
